(19) United States
(12) Patent Application Publication
(10) Pub. No.: US 2015/0260266 A1
(43) Pub. Date: Sep. 17, 2015

(54) AUTOMATED ROTATION CHANGE SYSTEM ORIENTED TO RICE HUSKING MACHINES

(71) Applicant: INDUSTRIAS MACHINA ZACCARIA S/A, Limeira (BR)

(72) Inventor: Luiz Aparecido BASSINELLO, Limeira (BR)

(21) Appl. No.: 14/486,756

(22) Filed: Sep. 15, 2014

(30) Foreign Application Priority Data
Mar. 11, 2014 (BR) 102014005562 2

(51) Int. Cl. F16H 9/04; B02B 3/04; A23L 1/10

(52) U.S. Cl. CPC F16H 9/04; A23L 1/1025; B02B 3/045

(57) ABSTRACT

An automated rotation change system employed in a traditional rice husking machine including a feed hopper, that receives rice grains, connected to a feed header set and a vibrating chute system, a vertical chute, and a husking chamber set, that includes rubber rollers. The rotation change system includes a motor connected to a first pulley that activates, by a belt, a second pulley of a first shaft. The first shaft is connected to a fourth pulley, which activates a fifth pulley of a second shaft together with tightening pulleys on a third and fourth shaft. The fifth pulley transmits rotation to rubber roller of a mobile hub. The third pulley activates the sixth pulley. The seventh pulley is connected to and activates an eight pulley on the fourth shaft, thus making a rubber roller of a fixed hub rotate faster than the roller of the mobile hub.

### BACKGROUND OF THE INVENTION

1. Field of the Invention

The present invention relates to to rice husking machines, and more particularly to a rotation change system between husking rollers.

2. Description of the Background Art

In the industrial sector of rice husking machines, technological evolution is oriented for improvements in order to attain higher production, longer durability of the rubber rollers and higher yielding in the efficiency of rice husking, known as “husking index”.

Technological developments were applied, aiming at producing pieces of equipment that actually bring in higher productive capacity and efficiency in rice grains husking.

Traditionally, rice grains are husked as they undergo the pressure of a pair of rubber rollers, mechanically activated by an electrical motor. Such rollers rotate in opposite directions and in different rotations so that the peripheral speed of a roller remains higher than the peripheral speed of the other one. These peripheral speeds are transferred to the rice grain husk, thus creating a tendency to displace one side of the husk more than the other. This effect provokes the rupture and the release of the rice grain husks.

The difference in the peripheral speed between the rollers is an important parameter for the husking process, and ideally, its value should remain constant. The pressure exerted on the husk by the rollers is controlled by the operators through the distance between the rollers (known as clearance). Such clearance should be the minimum needed to ensure contact of the rollers with the grains and transmit enough pressure to establish a friction force between the surface of the rubber rollers and the surface of the husk.

In addition to these two parameters, the positioning and input speed of the grains into the roller will also determine husking efficiency and rice breakage rate in the system. The angulation between the rollers induces the grains to fall perpendicularly, and the feeding of grains into the equipment is top-down, accomplished by means of hoppers or deposits.

In spite of the quest for higher production levels, rubber rollers have an increasingly shorter life cycle, which is attributable to the fact that with the increase in production levels, there is also a considerable increase in the power involved in the system activation.

The faster the roller rotates, the faster it wears out. Along the process, the diameter of the roller becomes shorter in comparison to the diameter of the other roller, thus making the clearance between both rollers larger and their peripheral speeds increasingly closer, thus eliminating the gliding effect and reducing husking process efficiency. In order to avoid this problem, the operator must adjust the clearance between the rollers in order to reestablish the required pressure. However, when the difference between peripheral speeds falls to below a minimum value, the husking index also falls. Since most operators do not have the whole picture, they frequently keep increasing the pressure, trying to improve the husking index. But this is useless, since it does not affect the difference between the peripheral speed of the rollers. On the contrary, the excessive pressure is transmitted to the rice grains, yielding internal pressures and provoking its breakage. Such breakage yields a negative impact. Another important index is the rice breakage rate. Since the whole grain possesses higher commercial value than a fractured grain. Thus, this rate may incur financial loss.

The increase in pressure also provokes an increase in the temperature of the rollers, thus speeding up their wearing process and considerably reducing their life cycle. The need for changing rollers becomes more frequent, thus yielding another financial loss for the rice processing industry.

Both problems, the increase in rice grain breakage rate and excessive outwearing of rollers, can be avoided by the operator. The operator should halt the machine and manually change the positioning of the rollers, placing the broader roller in the higher-rotation shaft and the narrower roller in the lower-rotation shaft. Once again, this manual change entails a difference in peripheral speed among the rollers (a requirement for the husking process). However, if the operator delays this change, the difference in the diameter of the rollers will result in a large difference in peripheral speed, which also entails an excessive outwearing of rollers. Thus, a new process cycle begins, which is repeated until the full corrosion of rollers, when then they must be replaced by new ones.

The machine arrest for manual change of rollers position is one of the reasons for efficiency loss in the husking process, since this change does not always take place at the ideal moment. When there is a delay in roller change, the above mentioned problems occur. When the change is made before the ideal moment, it is advantageous to the husking process, since it contributes to maintaining the peripheral speed of the rollers. However, the manual change is not a fast process. That is, one has to loosen the screws that fasten the rollers, change their position, screw them back in and check the balancing of the rollers. That is the reason why excessive manual changes may be responsible for loss of time in the process (machine out of operation).

### SUMMARY OF THE INVENTION

In view of the problems above mentioned related to the prior art, the present invention provides an automated rotation change system, which comprises position sensors that constantly monitor the diameter of the rollers and inform excessive outwearing. At that moment, a rotation change system is activated, changing the rotation of the shafts, causing the previously slower rotating roller to rotate faster than the other roller. The present invention provides higher operational reliability, longer life cycle for rubber rollers and eliminates roller unbalancing issues, due to manual change and improvements in its general efficiency

As a practical result, the present invention considerably reduces the out-of-operation time of the machine in order to change the position of the rollers, increases the life cycle of the rollers and reduces the rice grain breakage rate.

### BRIEF DESCRIPTION OF THE DRAWINGS

The present invention will become more fully understood from the detailed description given hereinbelow and the accompanying drawings which are given by way of illustration only, and thus, do limit the present invention, and wherein: FIG. 1 illustrates a traditional rice husking machine;

FIG. 2 illustrates the outwearing process of the rollers and the variation of peripheral speed;

FIG. 3 illustrates an exemplary embodiment of the present invention;

FIG. 4 is a diagram illustrating a set of pulleys and gear according to an exemplary embodiment of the invention;

FIG. 5 further illustrates the gear set according to an exemplary embodiment of the invention.

### DETAILED DESCRIPTION OF EXEMPLARY EMBODIMENTS OF THE PRESENT INVENTION

The following detailed description should be read and interpreted in accordance with FIGS. 1-5, which is not intended to restrict the scope of the invention, but restricted to what has been stated in the claim scope.

FIG. 1 represents a traditional rice husking machine, comprised by a feed hopper (1), that receives rice grains in the husk, connected to a feed header set (2) and a vibrating chute (3), a vertical chute (4), and a husking chamber set (5) that also contains rubber rollers (6)(7).

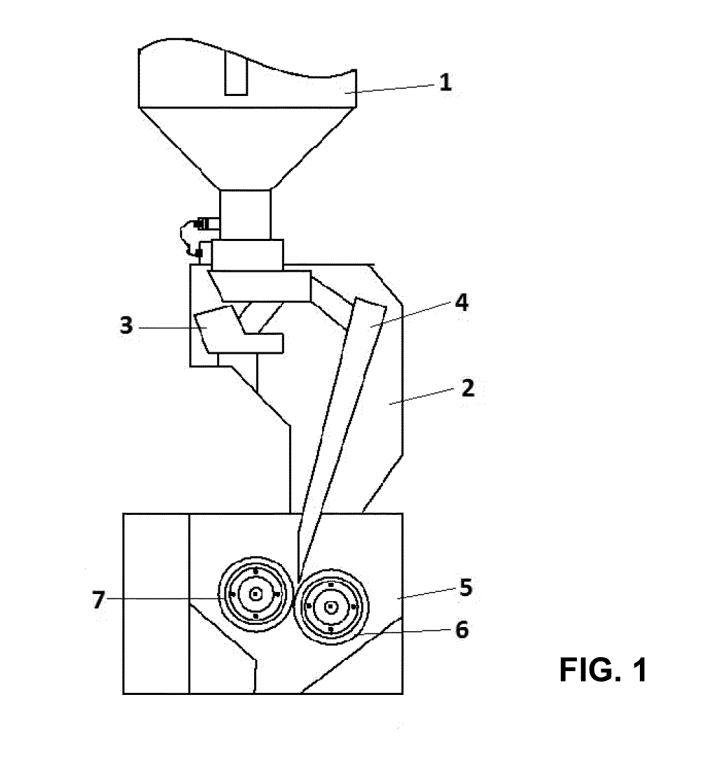

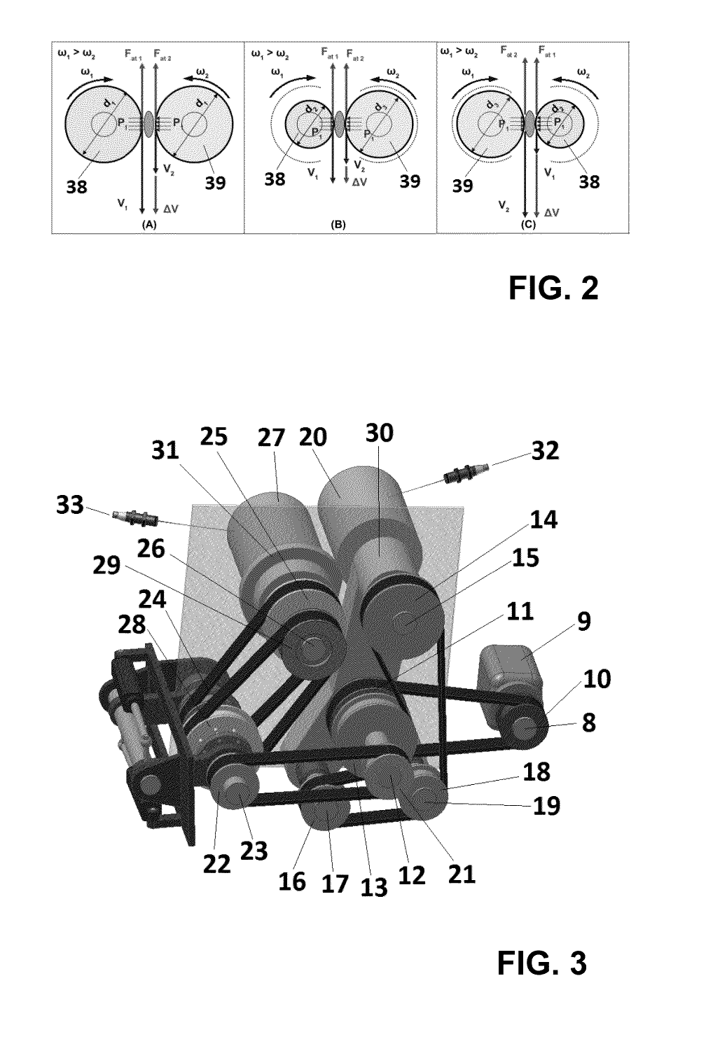

FIG. 2 shows the variation of peripheral speed based on the outwearing of the rollers.

FIG. 2-A represents the initial situation, in which the rollers (38) (39) have the same diameter. Rotation (ω1) of roller (38) is higher than the rotation (ω2) of roller (39), and that is the reason why the peripheral speed on the surface of roller (38) is higher than the peripheral speed on the surface of roller (39). Both rollers exert a pressure (P₁) on the rice grain, generating a friction force (Fₐₜ₁ and Fₐₜ₂) between the surface of the rollers and the surface of the rice grain husks.

FIG. 2-B presents the same situation of FIG. 2-A, later in the husking process. It is noticeable that both rollers suffered outwearing and reduction in their diameters, but the fastest-rotating roller (38) is more worn out. For this reason their peripheral speeds (V₁ and V₂) decreased and consequently the difference between them (ΔV), which is responsible for the husking index also decreased, thus also reducing the husking index of the grains.

FIG. 2-C shows the solution presently in practice. The operators revert the positioning of the rollers in order to reestablish the peripheral speed difference (ΔV). When the difference in the diameters of the rollers is high, however, the peripheral speed difference increases to above the ideal value, thus accelerating the outwearing process of rollers.

FIG. 3 illustrates a rotation change system that comprises a motor (9) connected to a pulley (10), which activates, through belts, the pulley (13) of a shaft (12). The shaft (12) transmits rotation to the pulley (13) that activates pulley (14) of the shaft (15), which begins to rotate in the reverse direction, together with the tightening pulley (16) on shaft (17) and the tightening pulley (18) on shaft (19).

Pulley (14) transmits rotation to rubber roller (20) of the mobile hub (30). On shaft (12), pulley (21) is also activated and is connected to pulley (22) of shaft (23) of the automated rotation change box. Initially, pulley (28) is connected to shaft (23) and activates pulley (29) of shaft (26) thus making rubber roller (27) of fixed hub (31) rotate faster than roller (20) of the mobile hub (30).

When roller (27) of the fixed hub (31) is more outworn than roller (20) of the mobile hub (30) beyond tolerance limits, sensors (32) and (33) send a signal to the Programmable Logic Controller (PLC) that activates the actuators, disconnecting pulley (28) from shaft (25) and connecting pulley (24) of shaft (23) connected to pulley (25). This induces roller (27) of the fixed hub (31) on shaft (26) to rotate more slowly than roller (20) of the mobile hub (30) on shaft (15). Besides this reduction system, a frequency inverter is also activated in order to increase the rotation of roller (20) of mobile hub (30). The process is repeated until both rollers are completely worn out, at the end of their life cycle.

Thus, the rotation change system allows that, by means of a sole motor, sensors, a frequency inverter, a set of pulleys and driving belts, and a gear mechanism, the speed of both rollers be changed only by acting on a switch. This enables the rice husking machine to eliminate the manual operation for changing rollers in order to compensate outwearing.

The result is a longer operational time period with higher yielding, whereas the PLC monitors working conditions and implements speed changing among the rubber rollers.

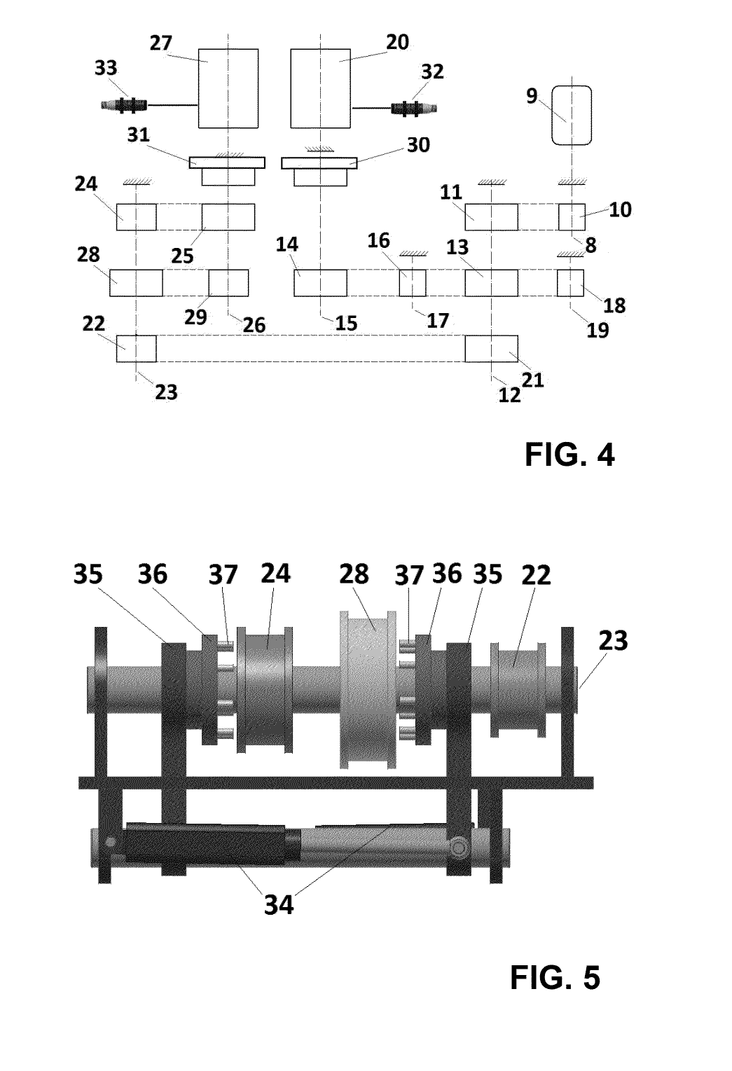

FIG. 4 represents, in a planned and schematic manner, the relationship of transmission between shafts and pulleys.

FIG. 5 represents the detail of the gear, comprised by one pulley (22) that rotates the shaft (23). If pulley (28) is connected, pulley (24) will be disconnected (loose) and vice-versa. This connection is made by means of two pneumatic actuators (34) mounted in opposing operating directions. The two pneumatic actuators activate the forks (35) attached to the hubs (36).

These hubs (36) are connected to the shaft (23) and they have pins (37) that fit into pulleys (24) and (28). They are responsible for power transmission.

The way of accomplishment described in this topic of construction detailing is provided as an illustration only. Changes, modifications and variations might be applied to any other forms of construction accomplishment by those skilled in the area; however, this should not escape from the objective revealed in the patent application, which is exclusively defined by the claims attached.

1. An automated rotation change system incorporated in a husking machine, the husking machine comprising a feed hopper, that receives rice grains, connected to a feed header set, and a vibrating chute system, a vertical chute, and a husking chamber set that including rubber rollers, said automated a rotation change system comprising:
a motor;
a first pulley connected to the motor;
a first shaft having a second pulley and a third pulley disposed on the first shaft, the first pulley activating, through a belt, the second pulley;
a fourth pulley;
a second shaft having a fifth pulley formed thereon;
a third shaft and a fourth shaft each having a tightening pulley formed thereon;
a mobile hub having a rubber roller disposed thereon;
a third shaft having a sixth pulley disposed thereon;
a seventh pulley;
a fourth shaft having an eight pulley disposed thereon; and
a fixed hub having a rubber roller disposed thereon,
wherein the first shaft is configured to transmit rotation to the fourth pulley, which activates the fifth pulley of the second shaft together with the tightening pulleys on the third and fourth shafts,
wherein the fourth pulley transmits rotation to the rubber roller of the mobile hub,
wherein the third pulley connected to first shaft activates the sixth pulley on the third shaft,
wherein the seventh pulley is connected to and activates the eight pulley on the fourth shaft thus making the rubber roller of the fixed hub rotate faster than roller of the mobile hub.

2. The automated rotation change system according to claim 1, further comprising:
a plurality of sensors configured to send signals to a programmable logic controller (PLC), which activates a plurality of actuators, the seventh pulley that is a disconnecting pulley and a connecting pulley, thus making the fourth shaft and the roller of the fixed hub rotate slower than second shaft and the roller of the mobile hub; and
a frequency inverter activated to increase the rotation of second shaft and the roller of the mobile hub.

3. The automated rotation change system according to claim 2, further comprising a gear that comprises the sixth pulley, which rotates the third shaft,
wherein when the disconnecting pulley is connected, the connecting pulley is disconnected, and when the connecting pulley is connected, the disconnecting pulley is disconnected.

4. The automated rotation change system according to claim 2, further comprising:
a plurality of hubs having forks attached to the hubs; and
two pneumatic actuators mounted in opposing operating directions, which activate the forks attached to the hubs, which are connected to the third shaft, and have pins that fit into the disconnecting pulley and the connecting pulley and are responsible for rotation transmission.
